(19) United States
(12) Patent Application Publication
(10) Pub. No.: US 2013/0050786 A1
(43) Pub. Date: Feb. 28, 2013

(54) Hogel Display using Optical Beam Oscillators

(71) Applicant: Mark E. Lucente, Austin, TX (US)

(72) Inventor: Mark E. Lucente, Austin, TX (US)

(73) Assignee: Zebra Imaging, Inc., Austin, TX (US)

(21) Appl. No.: 13/433,305

(22) Filed: Mar. 29, 2012

Related U.S. Application Data
(60) Provisional application No. 61/528,756, filed on Aug. 29, 2011.

(51) Int. Cl. G03H 1/08

(52) U.S. Cl. 359/9

(57) ABSTRACT

Methods and systems for generating a holographic light field, the method including converting provided hogel data into optical beam oscillator data, and generating a plurality of light beams using a plurality of optical beam oscillators. The optical beam oscillators are configured to receive the optical beam oscillator data and to oscillate in corresponding oscillating patterns to generate a light field such as a representation of a 3D image. The optical beam oscillator data is adapted to match the oscillating patterns of the optical beam oscillators, and the optical beam oscillators are configured to generate at least subsets of the light beams serially in time.

### A. PRIORITY CLAIM

This application claims the priority benefit, under 35 U.S.C.§119 (e), of U.S. provisional application, Ser. No. 61/528,756, filed on Aug. 29, 2011.

The above-referenced patents and/or patent applications are hereby incorporated by reference herein in their entirety.

### B. BACKGROUND

The invention relates generally to the field of using optical beam oscillators to implement hogel light modulators.

### C. SUMMARY

In one respect, disclosed is a method for generating a holographic light field, the method including receiving hogel data, converting the hogel data into optical beam oscillator data, and generating a plurality of light beams using a plurality of optical beam oscillators. The optical beam oscillators are configured to receive the optical beam oscillator data and to oscillate in corresponding oscillating patterns. The optical beam oscillator data is adapted to match the oscillating patterns of the optical beam oscillators, and the optical beam oscillators are configured to generate at least subsets of the light beams serially in time.

In another respect, disclosed is a system for generating a holographic light field, the system including a data adapting unit (which includes one or more processors coupled to one or more memory units) and a plurality of optical beam oscillators. The data adapting unit is configured to receive and convert hogel data into optical beam oscillator data. The optical beam oscillators are configured to receive the optical beam oscillator data, oscillate in corresponding oscillating patterns, and generate a plurality of light beams. The adapting unit is further configured to adapt the optical beam oscillator data to match the oscillating patterns of the optical beam oscillators. The optical beam oscillators are further configured to generate at least subsets of the light beams serially in time.

In yet another respect, disclosed is a computer program product embodied in a computer-readable medium. The computer program product comprises logic instructions that are effective to receive and convert the hogel data into optical beam oscillator data. The optical beam oscillator data is adapted to be provided to a plurality of optical beam oscillators. The optical beam oscillators are configured to receive the optical beam oscillator data, oscillate in corresponding oscillating patterns, and generate a plurality of light beams. The optical beam oscillator data is adapted to match the oscillating patterns of the optical beam oscillators, and the optical beam oscillators are configured to generate at least subsets of the light beams serially in time.

Numerous additional embodiments are also possible.

### D. BRIEF DESCRIPTION OF THE DRAWINGS

Other objects and advantages of the invention may become apparent upon reading the detailed description and upon reference to the accompanying drawings.

FIG. 1 is a block diagram illustrating a hogel light modulator utilizing optical beam oscillators, in accordance with some embodiments.

FIG. 2 is a diagram illustrating generated light beams using an optical beam oscillator, in accordance with some embodiments.

FIG. 3 is a block diagram illustrating a system that includes a hogel light modulator using optical beam oscillators, in accordance with some embodiments.

FIG. 4 is a diagram illustrating an example of an optical beam oscillator utilizing an oscillating micro-mirror, in accordance with some embodiments.

FIG. 5 is a diagram illustrating an example of an optical beam oscillator utilizing an oscillating fiber, in accordance with some embodiments.

FIG. 6 is a flow diagram illustrating a method for generating light beams using optical beam oscillators, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### E. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

A hogel display or hogel light modulator typically comprises an array of hogels arranged on a 2D surface. The hogel array may or may not be a regular array. For example, the hogel array may be denser in the middle than the edges of the hogel display. The hogel display is configured to modulate light not only as a function of location but also as a function of direction (or angle) as the light emerges from each hogel. In some embodiments, a hogel is substantially a point—a specific spatial element of hogel data—on the 2D surface from which light emerges having controlled color and intensity in different directions from the hogel.

Accordingly, values of intensity and color for a hogel display are associated with four coordinates: two for representing the hogel's spatial location on the surface and two more for representing the direction in which the light emerges from the hogel. Each physical hogel may be thought of as emitting a group of hogel or light beams (or generally a hogel light field) emerging from the hogel and travelling in different directions. Two coordinates may define the spatial location of the hogel on the 2D hogel surface and two angular coordinates may define a particular hogel beam of light emerging from the hogel. By being able to control the color and intensity of light in different directions emerging from multiple hogels, auto-viewable holographic 3D images may be generated. The auto-viewable 3D images can be experienced without additional equipment, such as special eyewear, and without the position of the eyes being required.

It should be noted that depending on the technology used to implement the hogel display, there may or may not be simple mapping between hogel data elements and resulting hogel beams (or hogel light field). For example, there may not be a one-to-one correspondence between hogel data elements and particular hogel beams but a many-to-many relationship may exist between hogel data elements and hogel beams (or hogel light field). Such may be the case, for example, when holographic optical elements are used. It should be noted that the 2D hogel surface may be of any shape such as flat, concave, convex, spherical, etc. as well as any 2D manifold—a 2D surface of essentially any shape (such as a piece of cloth).

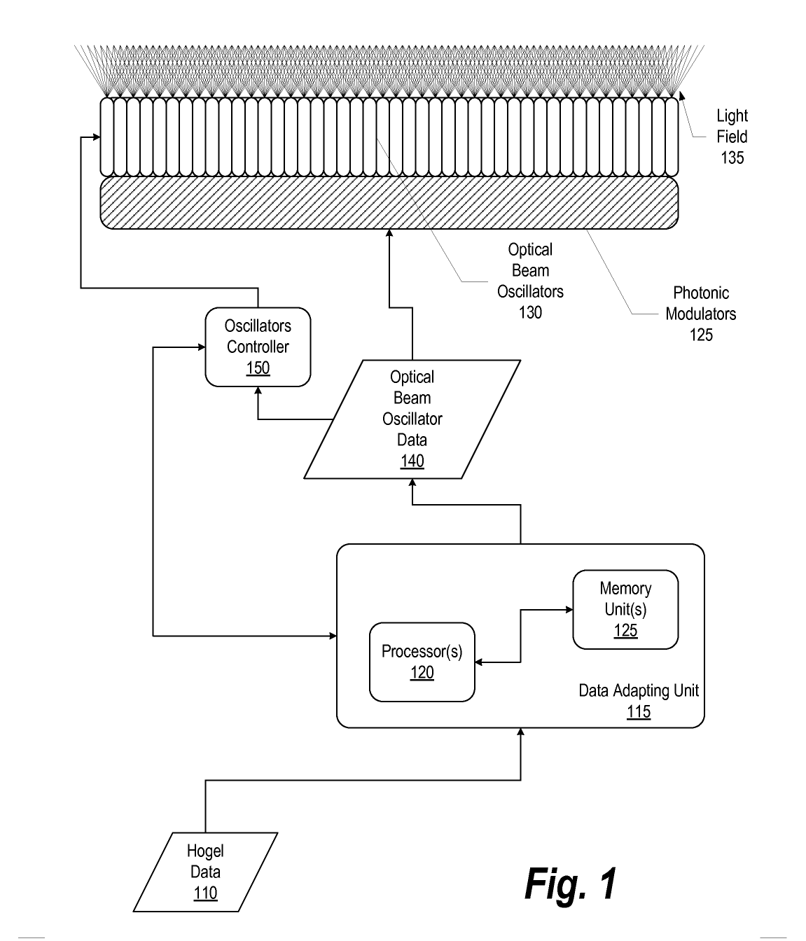

FIG. 1 is a block diagram illustrating a hogel light modulator utilizing optical beam oscillators, in accordance with some embodiments.

In some embodiments, data adapting unit 115 is configured to receive hogel data 110 and to convert hogel data 110 to optical beam oscillator data 140. In some embodiments, data adapting unit 115 may comprise one or more processors 120 and one or more memory units 125 (which are coupled to processors 120), which are configured to implement the functionality of data adapting unit 115.

In some embodiments, photonic modulators 125 are configured to receive optical beam oscillator data 140, convert the optical beam oscillator data 140 to modulated light, and provide the modulated light to optical beam oscillators 130 to generate a set of light beams that form light field 135. Oscillators controller 150 is configured to control the oscillation/scanning of optical beam oscillators 130. Optical beam oscillators 130 are configured to generate at least subsets of the light beams sequentially in time. In some embodiments, for example, a single hogel may be formed by generating each light beam in the hogel one after the other sequentially in time. It should be noted that in some embodiments, the functionality of photonic modulators 125 may be incorporated in optical beam oscillators 130. Similarly, the functionality of oscillators controller 150 may also be incorporated into optical beam oscillators 130. Accordingly, optical beam oscillators may additionally refer to a device that includes one or both of photonic modulators 125 and/or oscillators controller 150.

In some embodiments, the subset of light beams that are generated sequentially in time are generated within a time period that is less than the time a human eye requires to view the generated light field as one integrated image. In some embodiments, this time period is approximately 20 ms.

In some embodiments, optical beam oscillators 130 may be configured to cause light beams emerging from the oscillators to oscillate in two directional angles, φ & θ, about a fixed point (the origin of the hogel) in the range, (φₘᵢₙ-φₘₐₓ, θₘᵢₙ-θₘₐₓ), giving rise to a light field with full parallax. Various mechanical, electrical, optical, and other techniques may be used to cause the oscillations of the light beams. In some embodiments, the oscillations may be limited to only one directional angle, thereby generating a light field with half parallax. Examples of some of the ways to implement optical beam oscillators 130 is shown in some of the figures and described here.

In some embodiments, various groupings of the light beams may be implemented for the purpose of generating light beams from within each group serially in time in each cycle of the optical beam oscillators. In some embodiments, light beams from each group may be generated in phase; in other embodiments, the various groups may be staggered in phase. In yet other embodiments, other timings may be used between the various groups.

In some embodiments, for example, light beams corresponding to each hogel belong to the same group. In such embodiments, one optical beam oscillator may be assigned to each hogel, and each of the optical beam oscillators may oscillate in substantially the same pattern and are substantially in-phase with the other optical beam oscillators. In some embodiments, a frame of holographic video may be displayed in each oscillating cycle of the optical beam oscillators.

In some embodiments, other types of groupings may be used. For example, two or more optical beam oscillators may be configured to each generate a subset of the light beams in each hogel. For example, such implementation may be used in cases where a single optical beam oscillator is not able to scan a single hogel in short enough time. In cases where two oscillators are used per hogel, one of the optical beam oscillators may be used for angles in the range (φₘᵢₙ-φ_{mid}, θₘᵢₙ-θₘₐₓ) and the other optical beam oscillator may be used for angles in the range (φ_{mid}-φₘₐₓ, θₘᵢₙ-θₘₐₓ), where φ & θ are the solid angles about over each optical beam oscillator generates oscillating light beams.

In yet other embodiments, a single optical beam oscillator may be used to scan more than one hogel at a time. In some embodiments, photonic transmitters may be utilized. Photonic transmitters generally have a high bandwidth and are capable of tuning to various carrier wavelengths. Accordingly, a single photonic transmitter may be used to generate multiple sets of light beams. In some embodiments, each of the light beams may be modulated using the data received for the corresponding light beams. An optical wavelength demultiplexer (“demux”) may then be used to separate each of the light beams emitted by the optical beam oscillator into multiple light beams.

For example, if the refresh frame period is 20 ms and each hogel is formed using 10,000 samples/light beams, an optical beam oscillator would oscillate between light beams within that hogel every 2 μs in order to complete the cycle within 20 ms. Accordingly, if the optical beam oscillator alternates generating light beams for two hogels every 1 μs, for example, then two hogels may be generated from a single optical beam oscillator.

In some embodiments, each of optical beam oscillators may be configured to generate more than one light beam simultaneously. In such embodiments, higher angular resolutions may be achieved at the same scanning rate and at the same frame refresh rate.

In such implementations, data for each of the light beams that are to be simultaneously generated may be provided to each optical beam oscillator. The data may be provided in multiple distinct modes, a task that may be accomplished in a variety of ways. For example, in cases where a vibrating fiber assembly is used as the optical beam oscillator, in place of a single vibrating fiber (generating a single light beam at a time), a bundle of two or more fibers may be used, thereby generating two or more light beams at the same time. In other implementations, a fiber drawn from a photonic bandgap material may be used. Such fibers allow for multimodal transmission while maintaining spatial separation, within the same fiber, so that the each mode that is carrying a separate light beam signal may be directed in different directions.

In some embodiments, separate implementations may be used to implement the oscillations in each of the two angular directions. In some embodiments, light beams in one of the directions may be implemented using oscillations while light beams in the other directions may be implemented using a fixed array of light sources. In some embodiments, the array of light sources may be configured to oscillate only in one direction, while scanning in the other direction is unnecessary due to the fixed array of light sources.

In embodiments where color light fields (and corresponding color 3D images) are to be generated, the optical beam oscillators may be provided with modulated light in each of red, green, and blue, for example. In embodiments where vibrating fibers are used as part of the optical beam oscillators, each of the three (or more) modulated color beams may be combined and provided to the fiber. Similarly, in embodiments where vibrating mirrors are used as part of the optical beam oscillators, the beam used in those implementations may also be formed by combining the three (or more) modulated color beams.

In some embodiments, the scanning range of an optical beam oscillator can be adjusted by trading angular image resolution with the range of the angular scan angles (and therefore range of viewing angles). For example, if the optical beam oscillator can generate 100 different emission angles (in one angular dimension) during the refresh period/frame, the optical beam oscillator may be electronically driven to sweep a +/−45-degree range of angles, which results in a certain level of angular precision.

If instead the optical beam oscillator is driven to sweep an angular range (by adjusting the electronics, etc.) that is half as wide, twice the level of angular precision may be achieved in the generated light field (and therefore twice the level of image resolution). Angular precision may be adjusted independently in the two lateral scan dimensions.

Additional optics may be used at the end of each optical beam oscillator to increase the fill factor for each hogel and further process the emitted beam, e.g., to effecting low-pass filtering.

In some embodiments, large amounts of energy may be required to drive all of the multiple optical beam oscillators. To reduce the amount of energy required to drive the multiple optical beam oscillators, the optical beam oscillators or subsets of the optical beam oscillators may be operated with a staggered phase with respect to each other. In some embodiments, the relative phase of groups of optical beam oscillators may be distributed in the interval 0-360°.

In such embodiments, on average, some of the optical beam oscillators may be in a state where they require energy to continue oscillating, and on average, some of the optical beam oscillators may be in a return state. Thus, since some of the optical beam oscillators are requiring energy and an equal part (in terms of energy) of the optical beam oscillators are releasing energy, to maintain the system in operation, energy is only required to overcome frictional losses.

This may be the case, for example, in embodiments where the load presented by the optical beam oscillators is mostly reactive (inductive or capacitive) In such cases, staggering the driving of the optical beam oscillators may result in an average load that is very small or nearly zero or generally a time-integrated power consumption per hogel that is very small or nearly zero. Optical beam oscillator data 140 is accordingly adapted to match the staggered timing of the optical beam oscillators.

In some embodiments, data adapting unit 115 is configured to receive hogel data 110 and to convert the data into optical beam oscillator data 140 according to the oscillating patterns of optical beam oscillators 130. In some embodiments, hogel data 110 represents 3D video frames, where each frame comprises the data for the multiple hogels. Original hogel data (prior to processing by data adapting unit 115) is intended to be displayed near-simultaneously in time for each frame on a typical hogel display/light modulator. Data adapting unit 115 is configured to convert such hogel data so that it is at least partially serialized in time.

For example, in embodiments where one optical beam oscillator is assigned to one hogel and each oscillator sequentially in time generates each of the light beams for that hogel, data adapting unit 115 is configured to take the data for each light beam in each hogel and place that data serially in the order in which the optical beam oscillators are to generate each light beam. For example, in cases where a rasterizing-type pattern is used, the optical beam oscillator data is pre-arranged to match that rasterizing pattern. In cases where a spiral oscillating pattern is used, the optical beam oscillator data is arranged in such a way as to match that the spiral pattern.

In some embodiments, additional adjustments may be performed to the optical beam oscillator data by data adapting unit 115 in order to match the oscillating patterns of the optical beam oscillators. For example, in addition to placing the data corresponding to each light beam in a specific order, various timing adjustments may be implemented. For example, in embodiments where a spiral oscillating pattern is used, the optical beam oscillators may expend more time oscillating towards the middle of the spiral compared to the outside of the spiral. Accordingly, the delivery of optical beam oscillator data is timed to match the timing of the scanning of the optical beam oscillators.

In some embodiments, general calibration may be performed on the device in order to increase the quality of the output.

In some embodiments, standard hogel data may be rendered and then adjusted according to the specific patterns of the optical beam oscillators used by data adapting unit 115. In other embodiments, using calibration data, hogel data 110 may be rendered according to the calibration information in order to better match optical beam oscillators 130 in terms of light beam direction, light beam origination, oscillation patterns, etc. In some embodiments, additional light sensors may be used on the device in order to assist in determining the light beams' directions, origination, timing patterns, etc.

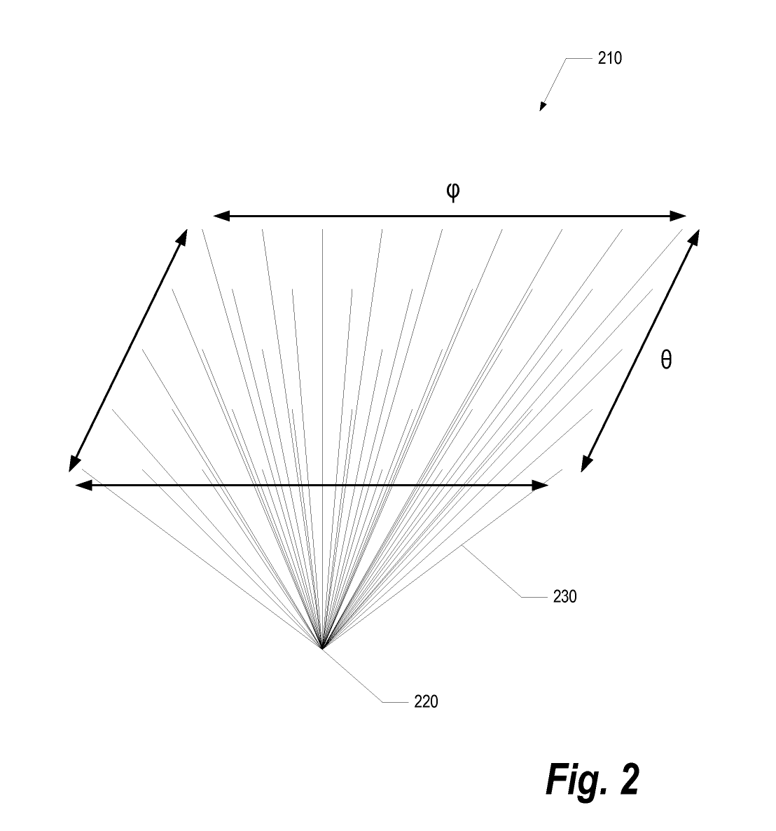

FIG. 2 is a diagram illustrating generated light beams using an optical beam oscillator, in accordance with some embodiments.

In some embodiments, cone 210 represents one possible light beam pattern generated by an optical beam oscillator in one cycle of the oscillator. Point 220 represents the virtual hogel point from where the light beams originate. Light beams 230 (as shown in the figure) are generated in rasterized patterns in angles φ and θ. In some embodiments, the φ angle may be scanned from a minimum to a maximum value while θ remains at a minimum value. θ may then be increased by one step, and φ may be scanned again in steps from the maximum value back to the minimum value. The process may repeat in a similar fashion until all the angles have been scanned. The process may then be repeated again for each scan cycle.

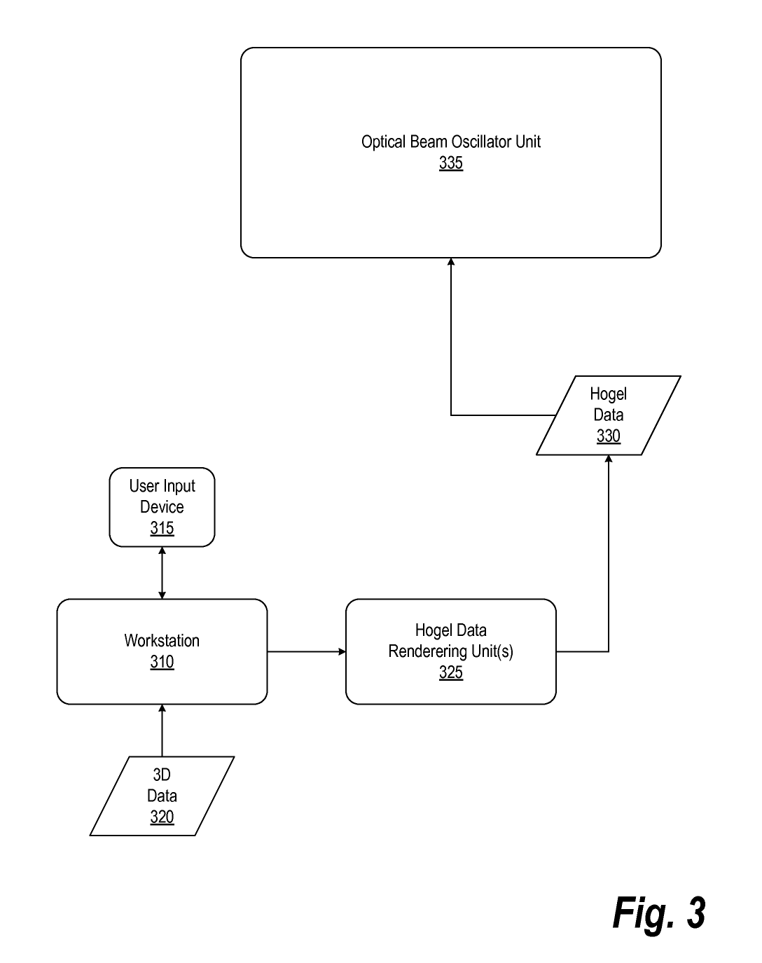

FIG. 3 is a block diagram illustrating a system that includes a hogel light modulator using optical beam oscillators, in accordance with some embodiments.

In some embodiments, workstation 310 is configured to receive input from one or more input devices 315 (which may include, keyboards, mice, microphones, cameras, network connected devices, etc.) and provide output through output devices 320 (which may include displays, speakers, network connected devices, etc.). In some implementations, workstation 310 is configured to output 3D data scene information to hogel rendering units 325 from a 3D-capable application executing on workstation 310.

In some embodiments, hogel data rendering units 325 are configured to receive 3D data scene information and generate hogel data. In some implementations, hogel data rendering units 325 may comprise multiple nodes executing in parallel and/or in series to generate hogel data 330.

Optical beam oscillator unit 335 is configured to receive hogel data 330 and generate a complex light field as described here by generating light beams, of which at least a subset is generated sequentially in time.

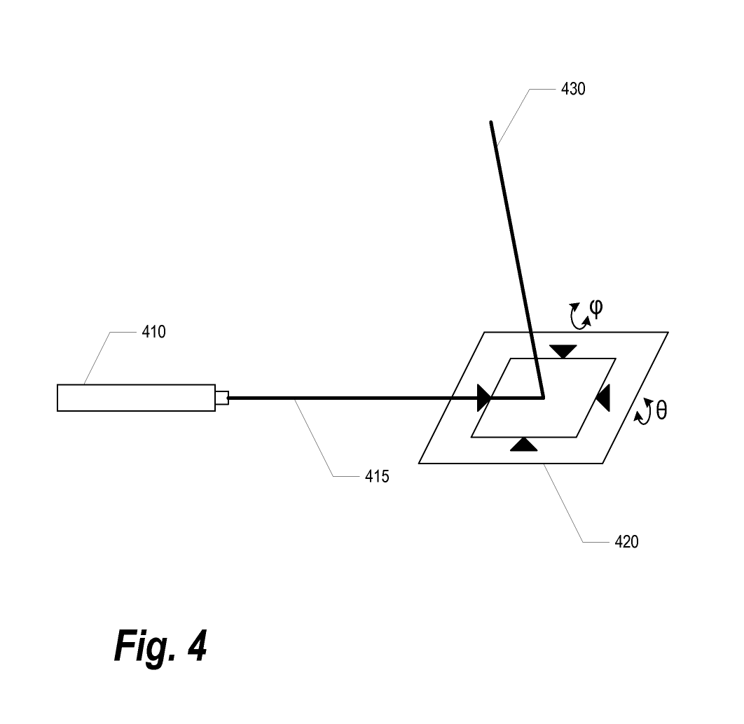

FIG. 4 is a diagram illustrating an example of an optical beam oscillator utilizing an oscillating micro-mirror, in accordance with some embodiments.

Light modulator 410 is configured to generate modulated light beam 415 and provide light beam 415 to oscillating mirror 420. In some embodiments, light modulator 410 is configured to generate light beams that are modulated with the intensity and color needed for light beam 430, which is the light beam output by the optical beam oscillator and used to generate the light field as described here.

Oscillating mirror 420 is configured to oscillate in two angular directions φ and θ. In some embodiments, oscillator controller 450 is configured to control the oscillating pattern of oscillating mirror 420. Oscillator controller 450 may be coupled to other systems, such as rendering systems, calibration systems, etc., to ensure that the timing and pattern of the oscillations of oscillating mirror 420 correspond to the timing and pattern of the modulations of light beam 415.

Oscillating mirror 420 may be configured to mechanically oscillate about two axis in a rasterizing pattern, for example, in a period equal to the period required by the system. In some embodiments, this period may be equal to the period of each holographic video frame, but as is described here, other periods may be used depending on the configuration in which the optical beam oscillator is used.

In some embodiments, scanning mirror 420 may be driven electrically, e.g., by electric fields applied by nearby electrodes, by piezoelectric actuators, or by some other type of actuators.

In some embodiments, when only half parallax images are needed, oscillating mirror 420 may be configured to oscillate in only one angular direction. An optical element, such as a cylindrical lens, may be used to diffuse the light beams in the other direction.

In some embodiments, optional optics may also be used in order to further adjust light beam 430 as needed. The optics may be used, for example, to focus or spread the beam, make the beam collimated, change the beam's direction, etc. It should be noted that, as needed, more complex optics may be used than what is shown in the diagram.

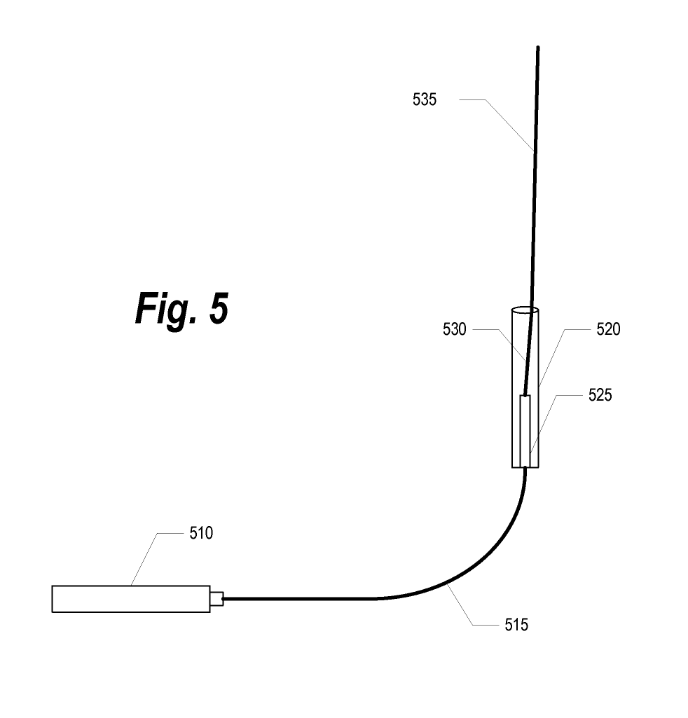

FIG. 5 is a diagram illustrating an example of an optical beam oscillator utilizing an oscillating fiber, in accordance with some embodiments.

Light modulator 510 is configured to generate modulated light and provide the modulated light through fiber optic cable 515 to oscillating/vibrating fiber assembly 520. In some embodiments, light modulator 510 is configured to generate light beams that are modulated with the intensity and color needed for light beam 530, which is the light beam output by the optical beam oscillator and used to generate the light field.

Oscillating fiber assembly 520 is configured to oscillate in two angular directions φ and θ such that resulting light beam 535 is output at those corresponding angles. In some embodiments, oscillator controller 550 is configured to control the oscillating patterns of oscillating fiber assembly 520. Oscillator controller 550 may be coupled to other systems, such as rendering systems, calibration systems, etc., to ensure that the timing and pattern of the oscillations of oscillating fiber assembly 520 correspond to the timing and pattern of the modulations of light beam 515.

Oscillating fiber assembly 520 may be configured to mechanically oscillate about two axis in a spiral pattern (among others patterns), for example, with a period equal to the period required by the optical beam oscillator. In some embodiments, this period may be equal to the period of each holographic video frame, but as is described here, other periods may be used depending on the configuration in which the optical beam oscillator is used.

In some embodiments, oscillating fiber assembly 520 may comprise mechanically oscillating fiber 530, which is provided modulated light through fiber optic cable 515. Oscillator 525 may be configured to cause the oscillations of oscillating fiber 530. In some embodiments, oscillator 525 may be configure to cause the oscillations electrically by using electric fields, for example, applied by nearby electrodes, by using piezoelectric actuators, or by using some other types of actuators. Typically, the oscillating pattern may be spiral, expanding from the central axis to larger and larger circles, reaching a maximum, and then returning to the center to repeat the refresh cycle.

In some embodiments, when only half parallax images are needed, oscillating fiber assembly 520 may be configured to oscillate only in one angular direction. An optical element, such as a cylindrical lens, may be used to diffuse the light beams in the other direction.

In some embodiments, optional optics 532 may also be used in order to further adjust light beam 535 as needed. The optics may be used, for example, to focus or spread the beam, make the beam collimated, change the beam's direction, etc. It should be noted that, as needed, more complex optics may be used than what is shown in the diagram. In some embodiments, the optics may be treated or coated to increase the output coupling efficiency. In some embodiments, either in addition or instead of optics 532, optics may also be mounted on the tip of oscillating fiber 530. In addition to providing optical changes to the light beam, the mass of the optics may be used to alter the oscillating characteristics of oscillating fiber 530 (such as resonant frequency).

The oscillations are synchronized with the adapted hogel data so that the correct light field is generated. Emitted light sweeps over a range of specific emission angles over the refresh period. For example, for a refresh period of 20 ms and a hogel fiber oscillating at 5000 Hz (i.e., each roughly circular sweep requires 200 μs), the hogels can sweep 100 circles per cycle period.

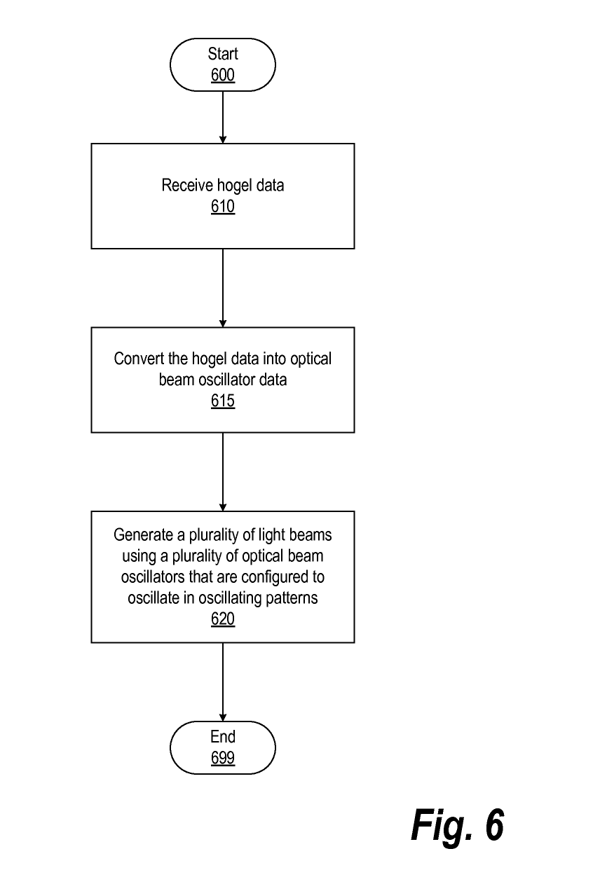

FIG. 6 is a flow diagram illustrating a method for generating light beams using optical beam oscillators, in accordance with some embodiments.

In some embodiments, the method illustrated in this figure may be performed by one or more of the systems illustrated in FIGS. 1, 3, 4, & 5.

Processing begins at 600 where, at block 610, hogel data is received, and at block 615, the hogel data is converted to optical beam oscillator data.

At block 620, a plurality of light beams is generated using a plurality of optical beam oscillators that are configured to receive the optical beam oscillator data and to oscillate in corresponding oscillating patterns.

In some embodiments, the optical beam oscillator data is adapted to match the oscillating patterns of the optical beam oscillators. For example, the timing when the data for each light beam is delivered is adapted to match the oscillating pattern of a corresponding optical beam oscillator.

In some embodiments, the optical beam oscillators are configured to generate at least subsets of the light beams serially in time.

Processing subsequently ends at 699.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for generating a light field, the method comprising:
being provided with hogel data;
converting the hogel data into optical beam oscillator data;
generating a plurality of light beams using a plurality of optical beam oscillators, where the optical beam oscillators are configured to receive the optical beam oscillator data and to oscillate in corresponding oscillating patterns;
where:
the optical beam oscillator data is adapted to match the oscillating patterns of the optical beam oscillators, and
the optical beam oscillators are configured to generate at least subsets of the light beams serially in time.

2. The method of claim 1, where all of the oscillating patterns correspond to a common oscillating pattern.

3. The method of claim 1, where each of the optical beam oscillators is configured to generate a single hogel using a single oscillating light beam.

4. The method of claim 1, where each of the optical beam oscillators is configured to generate two or more light beams simultaneously.

5. The method of claim 1, where two or more of the optical beam oscillators are configured to generate a single hogel.

6. The method of claim 1, where one or more of the optical beam oscillators comprise at least one of:
an oscillating mirror assembly; and
an oscillating fiber assembly.

7. A system for generating a holographic light field, the system comprising:
a data adapting unit, the data adapting unit comprising one or more processors coupled to one or more memory units, where the data adapting unit is configured to be provided with and convert hogel data into optical beam oscillator data;
a plurality of optical beam oscillators coupled to the adapting unit and configured to:
receive the optical beam oscillator data,
oscillate in corresponding oscillating patterns, and
generate a plurality of light beams,
where the adapting unit is further configured to adapt the optical beam oscillator data to match the oscillating patterns of the optical beam oscillators, and where the optical beam oscillators are further configured to generate at least subsets of the light beams serially in time.

8. The system of claim 7, where all of the oscillating patterns correspond to a common oscillating pattern.

9. The system of claim 7, where each of the optical beam oscillators is configured to generate a single hogel using a single oscillating light beam.

10. The system of claim 7, where each of the optical beam oscillators is configured to generate two or more light beams simultaneously.

11. The system of claim 7, where two or more of the optical beam oscillators are configured to generate a single hogel.

12. The system of claim 7, where one or more of the optical beam oscillators comprise at least one of:
an oscillating mirror assembly; and
an oscillating fiber assembly.

13. A computer program product embodied in a computer-readable medium, the computer program product comprising logic instructions, the logic instructions being effective to:
be provided with hogel data; and
convert the hogel data into optical beam oscillator data,
where
the optical beam oscillator data is adapted to be provided to a plurality of optical beam oscillators, where the optical beam oscillators are configured to:
receive the optical beam oscillator data,
oscillate in corresponding oscillating patterns, and
generate a plurality of light beams,
the optical beam oscillator data is adapted to match the oscillating patterns of the optical beam oscillators, and the optical beam oscillators are configured to generate at least subsets of the light beams serially in time.

14. The product of claim 13, where all of the oscillating patterns correspond to a common oscillating pattern.

15. The product of claim 13, where each of the optical beam oscillators is configured to generate a single hogel using a single oscillating light beam.

16. The product of claim 13, where each of the optical beam oscillators is configured to generate two or more light beams simultaneously.

17. The product of claim 13, where two or more of the optical beam oscillators are configured to generate a single hogel.

18. The product of claim 13, where one or more of the optical beam oscillators comprise at least one of:
an oscillating mirror assembly; and
an oscillating fiber assembly.
